(19) United States
(12) Patent Application Publication
(10) Pub. No.: US 2011/0163676 A1
(43) Pub. Date: Jul. 7, 2011

(54) Current Limiting Shut-Off Circuit for LED Lighting

(76) Inventors: Fred Farzan, Beverly Hills, CA (US); Christopher D. Johnston, Yorba Linda, CA (US)

(21) Appl. No.: 12/683,277

(22) Filed: Jan. 6, 2010

(51) Int. Cl. H05B 37/02

(52) U.S. Cl. 315/125

(57) ABSTRACT

A current limiting recessed lighting fixture prevents operation with lamps exceeding a rated wattage. Laws coming into effect place limits on lamp power consumption. The laws require that light fixtures include features to prevent a compliant lamp being later replaced by a higher wattage lamp. Further, limits have been placed on air flow from recessed lighting fixtures into ceiling plenums resulting in retention of heat in fixtures. Most high efficiency lamps include heat producing circuits in the lamp base and recessed lighting fixtures suitable of a lower wattage high efficiency lamp may overheat if a higher wattage replacement lamp is installed. Such overheating may drastically shorten the life if expensive LED lamps. The current limiting recessed lighting fixture shuts off when a lamp is installed which draws current above the rating for the fixture thereby addressing both the requirements of the new laws and also the potential overheating.

### BACKGROUND OF THE INVENTION

The present invention relates to lighting and in particular to fixtures for use with LED low wattage lighting.

A large portion of the use of electricity is to provide lighting. In the past, residential lighting generally utilized incandescent lamps. Such incandescent lamps convert about ten percent of power received to visible light and 90 percent to heat. Due to rising energy costs, there is a growing desire to replace incandescent lamps with more efficient lamps, for example, fluorescent and LED lamps. Further, laws have been passed setting future dates for elimination of incandescent lamps.

Title 24, Part 6, of the California Code of Regulations was established in 1978 to reduce energy consumed by residential and nonresidential lighting. Title 24 requires the use of energy efficient lighting and is periodically updated as technology evolves. The requirements were last updated in 2008 and these changes are effective in 2010. One component of Title 24 is that in recessed lighting fixtures are limited to accepting low wattage lighting.

Lamps are made with several sized bases, for example, a typical 40 to 150 watt residential incandescent lamp has an E26 (Edison 26 mm diameter) threaded base. A large variety of mounting fixtures are in production for such incandescent lamps, and retooling production lines to produce and/or incorporate a new base size is a major expense.

Further, limits (for example, the Washington State Energy code) have been places on the amount of heated air flow from a recessed lighting fixture into a ceiling plenum. High efficient lamps (both fluorescent and Light Emitting Diode (LED)) designed as a direct screw in replacement for incandescent lamps include circuits in the lamp bases required by the fluorescent and LED lights. Such circuits produce some heat which is higher in the fixture than the heat source of an incandescent lamp. Although the light fixtures can be designed to meet requirements, if a fluorescent or LED lamp with a wattage higher than the design wattage is installed into such a fixture, excessive heat may result. In particular, the life of LED lamps may be significantly shortened by the higher temperatures.

Therefore, a need remains for a recessed lighting fixture which accepts a standard base lamp while preventing the use of higher than designed for wattage lamps.

### BRIEF SUMMARY OF THE INVENTION

The present invention addresses the above and other needs by providing a current limiting recessed lighting fixture which prevents operation with lamps exceeding a rated wattage. Laws coming into effect place limits on lamp power consumption. The laws require that light fixtures include features to prevent a compliant lamp being later replaced by a higher wattage lamp. Further, limits have been placed on air flow from recessed lighting fixtures into ceiling plenums resulting in retention of heat in fixtures. Most high efficiency lamps include heat producing circuits in the lamp base and recessed lighting fixtures suitable of a lower wattage high efficiency lamp may overheat if a higher wattage replacement lamp is installed. Such overheating may drastically shorten the life if expensive LED lamps. The current limiting recessed lighting fixture shuts off when a lamp is installed which draws current above the rating for the fixture thereby addressing both the requirements of the new laws and also the potential overheating.

In accordance with one aspect of the invention, there is provided a current limiting recessed lighting fixture. The current limiting recessed lighting fixture includes a rough-in, a J-box mounted to the rough-in, and a housing mounted to the rough-in. Electrical connections in the J-box connect fixture wiring of the current limiting recessed lighting fixture to in-ceiling wiring in a ceiling plenum. The housing has a top and sides (called the round housing wrap), and an open bottom attached to the rough-in. The top and sides limit air flow from inside the housing into the ceiling plenum. A lamp socket resides inside the housing and is attached to the housing. The fixture wiring runs from the J-box into the housing and electrically connects to the lamp socket. A lamp is installed in the lamp socket and is electrically connected to the fixture wiring through the lamp socket for receiving electrical power to produce visible light. A current sensor in the housing is electrically connected to the fixture wiring in series with the lamp socket and senses current through the fixture wiring. An electrical switch resides in the housing and is electrically connected to the fixture wiring in series with the lamp socket and is controlled by the current sensor. The electrical switch opens to cut off electrical power conducted by the fixture wiring to the lamp socket when the current sensor senses an overcurrent.

### BRIEF DESCRIPTION OF THE SEVERAL VIEWS OF THE DRAWING

The above and other aspects, features and advantages of the present invention will be more apparent from the following more particular description thereof, presented in conjunction with the following drawings wherein:

FIG. 1 is a side view of a current limiting recessed lighting fixture according to the present invention.

FIG. 2 is a top view of the current limiting recessed lighting fixture according to the present invention.

FIG. 3 is a cross-sectional view of the current limiting recessed lighting fixture according to the present invention taken along line 3-3 of FIG. 2.

Corresponding reference characters indicate corresponding components throughout the several views of the drawings.

### DETAILED DESCRIPTION OF THE INVENTION

The following description is of the best mode presently contemplated for carrying out the invention. This description is not to be taken in a limiting sense, but is made merely for the purpose of describing one or more preferred embodiments of the invention. The scope of the invention should be determined with reference to the claims.

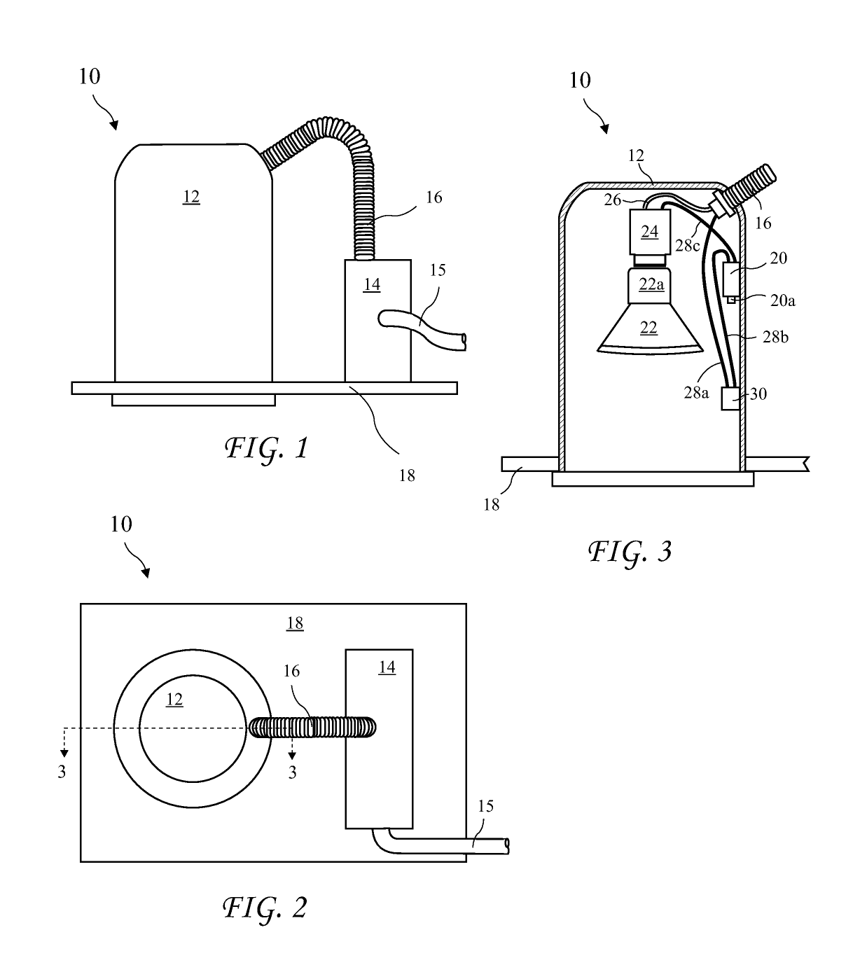

A side view of a current limiting recessed lighting fixture 10 according to the present invention is shown in FIG. 1 and a top view of the current limiting recessed lighting fixture 10 is shown in FIG. 2. The current limiting recessed lighting fixture 10 includes a J-box 14 attached to a rough-in 18 for electrically connecting to in-ceiling electrical wiring 15 in a ceiling plenum which the current limiting recessed lighting fixture 10 is mounted into. The in-ceiling electrical wiring 15 generally carries 120 volt AC 60 cycle household power commonly used throughout the United States. The housing 12 has a closed top, bottom and sides and gaskets are used to prevent the free flow of air from the housing 12 into the ceiling plenum. The J-box 14 and housing 12 are generally connected by armored cable 16 containing wires 26 and 28a (see FIG. 3). The interior of the J-box 14 may be accessed to electrically connect the wires 26 and 28a to ceiling wiring 15. The housing 12 is constructed to limit air flow from inside the housing 12 into the ceiling plenum.

A cross-sectional view of the current limiting recessed lighting fixture 10 taken along line 3-3 of FIG. 2 is shown in FIG. 3. The housing 12 contains a thermal switch 30 and electrical switch (or circuit breaker) 20 electrically connected in-series with a lamp socket 24 by wires 28a, 28b, and 28c. The thermal switch 30 is sensitive to temperature inside the housing 12 and opens the circuit to the lamp socket 24 if the temperature exceeds a temperature threshold T. The electrical switch 20 is controlled by a current sensor which may be a separate device, or a current sensor combined with the electrical switch as a current sensing circuit breaker 20. The wires 26 complete the circuit by connecting the lamp socket 24 back to the J-box 14. The lamp socket 24 is preferably configured to accept a lamp with a standard E24 Edison screw base. A high efficiency lamp 22 is installed in the lamp socket 24. The high efficiency lamp 22 includes a circuit 22a for processing the 120 volt AC 60 cycle household power into a suitable power signal. Such power signal processing generally creates heat, which may result in elevated temperatures inside the housing 12 due to the restricted air flow from the housing 12 into the ceiling plenum. Suitable high efficiency LED lamps are available from various LED lamp manufactures.

The present invention is essentially directed to comply with Title 24 of the California Energy Efficient Building standards and to also comply with the Washington State Energy Code which places limits on the amount of heated air flow from a recessed lighting fixture into a ceiling plenum. Title 24 requires that lighting fixtures are limited to only accepting low wattage lighting. While lighting fixtures could be designed with a new style of lamp socket to prevent using higher wattage than allowed lamps, such redesign would increase cost and limit the application of the fixture. Further, fluorescent and Light Emitting Diode (LED) lamps which satisfy Title 24 include a power signal processing circuit 22a near the base of the lamp 22. The circuit 22a resides somewhat centered in the housing 12 and heat generated by the circuit 22a does not freely escape thorough the bottom of the housing 12 into the room, or into the ceiling plenum, because of flow restrictions imposed by the Washington State Energy Code. Thus, Title 24 and the Washington State Energy Code impose a severe joint restriction on light fixture design which is compounded by the fact the LED lamp life is severely reduced by high temperatures, resulting in a reluctance to replace a short lived and expensive LED lamp with another expensive LED lamp, which defeats the purpose of Title 24.

The current limiting recessed lighting fixture 10 according to the present invention address Title 24 by adding the circuit breaker 20 matched to the housing 12 to both satisfy Title 24 by tripping when an energy efficient lamp 22 is replaced by any higher wattage lamp, and also address the heat issues in the housing 12 caused by the air flow rate limitation in the Washington State Energy Code. Specifically, the circuit breaker is matched to the current drawn by the lamp which the housing is designed for. For example, a four inch diameter housing 12 is intended to receive a seven watt LED lamp. Thus, an approximately 0.02 amp circuit breaker is included in the four inch diameter housing and the circuit breaker will open the circuit (i.e., turn off the light) if a greater than seven watt current is experienced. Five and six inch diameter housings are used for 22 watt LED lamps, and an approximately 0.3 amp circuit breaker is used. As a result, the light fixture accepts standard base lamps, but will quickly turn off if too high of a wattage lamp is installed.

The circuit breaker is preferably a thermal circuit breaker Model number 106M2 made by ETA in Mount Prospect, Ill.

While the invention herein disclosed has been described by means of specific embodiments and applications thereof, numerous modifications and variations could be made thereto by those skilled in the art without departing from the scope of the invention set forth in the claims.

I claim:

1. A current limiting recessed lighting fixture comprising:
a rough-in;
a J-box mounted to the rough-in for electrically connecting the current limiting recessed lighting fixture to in-ceiling wiring in a ceiling plenum;
a housing mounted to the rough-in and having a top, a round housing wrap, and an open bottom attached to the rough-in, the top and the round housing wrap limiting air flow from inside the housing into the ceiling plenum for complying with Washington State Energy codes for air tight housings;
a lamp socket configured to accept a lamp with an E27 screw base and residing inside the housing and attached to the housing;
fixture wiring electrically connecting the J-box to the lamp socket;
an LED lamp having the E27 screw base and not exceeding current limitations of the lighting fixture, the LED lamp installed in the lamp socket and electrically connected to the fixture wiring through the lamp socket for receiving electrical power to produce visible light;
a thermal switch electrically connected to the fixture wiring in series with the lamp socket, the thermal switch sensitive to temperature inside the housing and opening to cut off the electrical power conducted by the fixture wiring to the lamp socket if the temperature inside the housing exceeds a temperature threshold T; and
a circuit breaker residing in the housing and electrically connected to the fixture wiring in series with the lamp socket and the thermal switch, the circuit breaker sensing current through the fixture wiring and opening to cut off the electrical power conducted by the fixture wiring to the lamp socket if the current sensor senses a current exceeding the current limitations of the lighting fixture.

2. The current limiting recessed lighting fixture of claim 1, wherein the circuit breaker is a thermal overcurrent circuit breaker.

3. The current limiting recessed lighting fixture of claim 1, wherein the circuit breaker include a manual reset accessible inside the housing for resetting the electrical switch to close the electrical switch to provide electrical power conducted by the fixture wiring to the lamp socket.

4. The current limiting recessed lighting fixture of claim 3, wherein:
the housing is a four inch diameter housing;
the LED lamp is a seven watt LED lamp; and the current sensor is an approximately 0.02 amp circuit breaker.

5. The current limiting recessed lighting fixture of claim 3, wherein:
the housing is selected from the group consisting of a five inch diameter housing and a six inch diameter housing;
the LED lamp is a 22 watt LED lamp; and the current sensor is an approximately 0.3 amp circuit breaker.

6. A current limiting recessed lighting fixture comprising:
a rough-in;
a J-box mounted to the rough-in for electrically connecting the current limiting recessed lighting fixture to in-ceiling wiring in a ceiling plenum;
a housing mounted to the rough-in and having a top, a round housing wrap, and an open bottom attached to the rough-in, the top and the round housing wrap limiting air flow from inside the housing into the ceiling plenum;
a lamp socket residing inside the housing and attached to the housing;
fixture wiring electrically connecting the J-box to the lamp socket;
a lamp installed in the lamp socket and electrically connected to the fixture wiring through the lamp socket for receiving electrical power to produce visible light;
a current sensor in the housing and electrically connected to the fixture wiring in series with the lamp socket and sensing current through the fixture wiring; and
an electrical switch in the housing and electrically connected to the fixture wiring in series with the lamp socket and controlled by the current sensor, the electrical switch opening to cut off electrical power conducted by the fixture wiring to the lamp socket when the current sensor senses an overcurrent.

7. The current limiting recessed lighting fixture of claim 6, further including a thermal sensor in the housing and electrically connected to the fixture wiring in series with the lamp socket, the thermal sensor sensing temperature inside the housing and opening to cut off electrical power conducted by the fixture wiring to the lamp socket if the temperature exceeds a temperature threshold T.

8. The current limiting recessed lighting fixture of claim 7, wherein the electrical switch include a manual reset accessible inside the housing for resetting the electrical switch to close the electrical switch to provide electrical power conducted by the fixture wiring to the lamp socket.

9. The current limiting recessed lighting fixture of claim 8, wherein the lamp socket is configured to accept a lamp having a standard incandescent lamp base.

10. The current limiting recessed lighting fixture of claim 9, wherein the lamp is a Light Emitting Diode (LED) lamp having a standard incandescent lamp base.

11. The current limiting recessed lighting fixture of claim 10, wherein:
the current limiting recessed lighting fixture is configured to receive 120 volt household AC power; and
the LED lamp includes a circuit to process the 120 volt household AC power to provided a correct power signal for LED residing in the LED lamp.

12. The current limiting recessed lighting fixture of claim 8, wherein the current sensor and electrical switch comprise a circuit breaker.

13. The current limiting recessed lighting fixture of claim 12, wherein the current sensor and electrical switch comprise a circuit breaker.

14. The current limiting recessed lighting fixture of claim 13, wherein the circuit breaker is a thermal overcurrent circuit breaker.

15. The current limiting recessed lighting fixture of claim 6, wherein:
the housing is a four inch diameter housing;
the LED lamp is a seven watt LED lamp; and the current sensor is an approximately 0.02 amp circuit breaker.

16. The current limiting recessed lighting fixture of claim 6, wherein:
the housing is selected from the group consisting of a five inch diameter housing and a six inch diameter housing;
the LED lamp is a 22 watt LED lamp; and the current sensor is an approximately 0.3 amp circuit breaker.
